(19) United States
(12) Patent Application Publication
(10) Pub. No.: US 2006/0280976 A1
(43) Pub. Date: Dec. 14, 2006

(54) Fuel cell system

(75) Inventors: Hiroaki Hashigaya, Kanagawa (JP); Keisuke Suzuki, Kanagaawa (JP); Tetsuya Kamihara, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 10/568,579

(22) PCT Filed: Aug. 16, 2004
(86) PCT No.: PCT/JP04/12033

§ 371 Date: Feb. 17, 2006

(30) Foreign Application Priority Data
Sep. 5, 2003 (JP) 2003-314283

(51) Int. Cl. H01M 8/04; H01M 8/12

(52) U.S. Cl. 429/22; 429/25

(57) ABSTRACT

A fuel cell stack (1) comprises a reactive gas passage (115, 1c, 116, 1a) and a water passage (117, 1b) substantially parallel thereto, and a reactive gas is humidified by water permeating from the water passage (117, 1b) through a porous member (112a, 112c). The pressure reduction amounts in the reactive gas passage (115, 1c, 116, 1a) and the water passage (117, 1b) are respectively calculated based on the power generation load of the stack (1). From the pressure reduction amounts in the water passage (117, 1b) and the reactive gas passage (115, 1c, 116, 1a), the pressure of the reactive gas supplied to the reactive gas passage (115, 1c, 116, 1a) is controlled such that the difference in pressure between the reactive gas passage (115, 1c, 116, 1a) and the water passage (117, 1b) is within a predetermined range, whereby the reactive gas is humidified in a desirable state.

### FIELD OF THE INVENTION

This invention relates to control of pressure of reactive gas to be supplied to a fuel cell system.

### BACKGROUND OF THE INVENTION

JP 8-250130 A, published in 1996 by the Japan Patent Office, discloses a fuel cell stack in which cooling plates are arranged between fuel cells stacked together.

Water passages are formed in the cooling plates, and water in the water channels cools the fuel cells and, at the same time, is permeated through a porous plate and anode forming each fuel cell to be used to humidify a solid polymer electrolyte membrane.

### SUMMARY OF THE INVENTION

The degree to which the electrolyte membrane is humidified varies according to an amount of water permeated through the plate and evaporated into hydrogen and air. That is, the amount of water permeated from the water passage to the anode depends on the difference between the hydrogen pressure at the anode and the water pressure in the water passage. The amount of water transmitted from the water passage to the cathode depends on the difference between the air pressure at the cathode and the water pressure in the water passage.

Inside the fuel cell stack, hydrogen and air are consumed by the power generating reaction. As a result, the pressure of the hydrogen and air are diminished toward the downstream side. Further, the water is also consumed to humidify the hydrogen and air, so its pressure diminishes toward the downstream side. These changes in pressure depend on the power generating state of the fuel cell stack. Thus, it is difficult to ensure a desirable humidifying condition for hydrogen and air throughout the entire fuel cell stack solely by controlling the difference between the hydrogen/air pressure and the water pressure at the inlet of the fuel cell stack.

It is therefore an object of this invention to control the pressure of these fluids such that a desirable humidifying condition for the hydrogen and air can be achieved throughout the entire fuel cell stack.

In order to achieve the above object, this invention provides a fuel cell system comprising a fuel cell stack effecting power generation upon supply of a reactive gas. The fuel cell stack comprises a reactive gas passage and a water passage substantially parallel to the reactive gas passage. The reactive gas passage and the water passage are separated by a porous member. The reactive gas is humidified by water permeating through the porous member. The fuel cell system comprises a reactive gas pressure control valve which controls a reactive gas pressure supplied to the reactive gas passage, a water pressure sensor which detects a water pressure in the water passage and a programmable controller.

The controller is programmed to calculate a pressure reduction amount in the reactive gas passage based on a power generation load of the fuel cell stack, to calculate a pressure reduction amount in the water passage based on the power generation load of the fuel cell stack and to calculate, from the pressure reduction amount in the water passage and the pressure reduction amount in the reactive gas passage, a target pressure of the reactive gas supplied to the reactive gas passage such that a pressure difference between the reactive gas passage and the water passage is within a predetermined range. The controller is further programmed to control the reactive gas pressure control valve based on the target pressure.

The details as well as other features and advantages of this invention are set forth in the remainder of the specification and are shown in the accompanying drawings.

### BRIEF DESCRIPTION OF THE DRAWINGS

FIG. 1 is a schematic diagram showing the construction of a fuel cell system according to a first embodiment of this invention.

FIG. 2 is a schematic diagram showing the construction of a fuel cell according to the first embodiment of this invention.

FIG. 3 is a cross-sectional view of essential pars of the fuel cell taken along the line III-III of FIG. 2.

FIG. 4 is a block diagram illustrating reactive gas pressure controlling functions of a controller according to the first embodiment of this invention.

FIG. 5 is a diagram showing the characteristics of a map of a target water pump rotating speed stored in the controller.

FIG. 6 is a flowchart illustrating a gas pressure controlling routine executed by the controller.

FIG. 7 is a flowchart illustrating a hydrogen pressure setting sub-routine executed by the controller.

FIG. 8 is a flowchart illustrating an air pressure setting sub-routine executed by the controller.

FIG. 9 is a diagram showing the characteristics of a target gas pressure map stored in the controller.

FIG. 10 is a diagram showing the characteristics of a hydrogen pressure loss map stored in the controller.

FIG. 11 is a diagram showing the characteristics of a water pressure loss map stored in the controller.

FIG. 12 is a diagram showing the characteristics of an air pressure loss map stored in the controller.

FIG. 13 is a schematic diagram showing the construction of a fuel cell system according to a second embodiment of this invention.

FIG. 14 is a block diagram illustrating reactive gas pressure controlling functions of a controller according to the second embodiment of this invention.

FIG. 15 is a flowchart illustrating a water pump rotating speed control routine executed by the controller according to the second embodiment of this invention.

### DESCRIPTION OF THE PREFERRED EMBODIMENTS

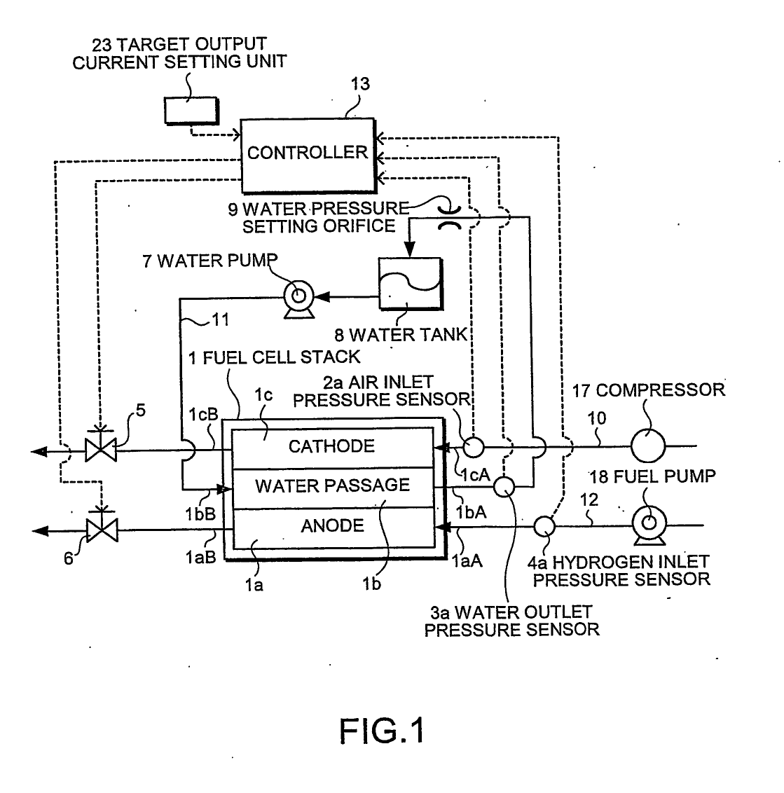

Referring to FIG. 1 of the drawings, a fuel cell stack 1 is formed by laminated fuel cells each of which comprises a cathode 1c to which air is introduced, an anode 1a to which hydrogen is introduced, and a water passage 1b to which water for humidification and cooling is introduced.

It should be noted that, in the drawing, the fuel cell stack 1 is depicted as if it is a unitary fuel cell for the explanatory purpose. A fuel cell system 20 comprises a compressor 17 for supplying air to the cathode 1c through an air pipe 10, and a fuel pump 18 for supplying hydrogen to the anode 1a through a hydrogen pipe 12.

The fuel cell system 20 further comprises, on the downstream side of the cathode 1c, an air pressure control valve 5 for adjusting an air pressure P_{A} in the cathode 1c. The fuel cell system 20 also comprises, on the downstream side of the anode 1a, a hydrogen pressure control valve 6 for adjusting a hydrogen pressure P_{H} in the anode 1a.

The fuel cell system 20 further comprises a water pump 7 for supplying water to the water passage 1b, and a water tank 8 for storing water flowing out of the water passage 1b for re-use. The fuel cell system 20 further comprises a water pipe 11 for circulating water between the water pump 7, the water passage 1b, and the water tank 8. The water pipe 11 is equipped with a water pressure setting orifice 9 for adjusting a water pressure P_{W} in the water passage 1b between the outlet of the water passage 1b and the water tank 8.

To effect humidification of the reactive gas and cooling of the fuel cell stack 1, the water pump 7 supplies the water in the water tank 8 to the water passage 1b of the fuel cell stack 1 through the water pipe 11.

Herein, the reactive gas denotes the hydrogen supplied to the anode 1a and the air supplied to the cathode 1c. Part of the water in the water passage 1b is used to humidify the reactive gas. The water not used in humidification effects heat exchange in the fuel cell stack 1 and is recovered by the water tank 8 by way of the water pressure setting orifice 9.

Next, the construction of the fuel cell stack 1 will be described.

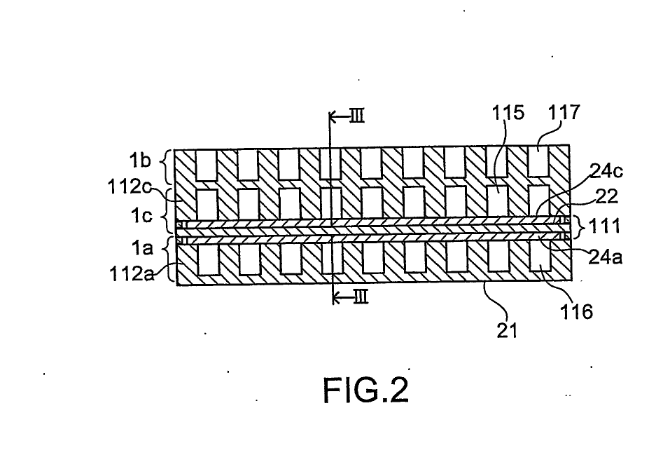

The fuel cell stack 1 is formed by a plurality of fuel cells 21. Referring to FIG. 2, each fuel cell 21 is equipped with a membrane electrode assembly (MEA) 111 sandwiched between plates 112a and 112c. The MEA 111 is composed of a solid polymer electrolyte membrane 22, an anode gas diffusion electrode 24a and a cathode gas diffusion electrode 24c.

The electrodes 24a, 24c are respectively bonded to either side of the solid polymer electrolyte membrane 22. Each of the anode gas diffusion electrode 24a and the cathode gas diffusion electrode 24c is composed of a catalyst layer in contact with the solid polymer electrolyte membrane 22, and a gas diffusion layer arranged on the outer side thereof.

The plate 112a is formed of an electrically conductive porous material, and is equipped with a hydrogen passage 116 facing the anode gas diffusion electrode 24a. The plate 112c is formed of an electrically conductive porous material, and is equipped with an air passage 115 facing the cathode gas diffusion electrode 24c. The plate 112c is further equipped with a water passage 117 parallel to the air passage 115 on the side opposite to its surface facing the cathode gas diffusion electrode 24C.

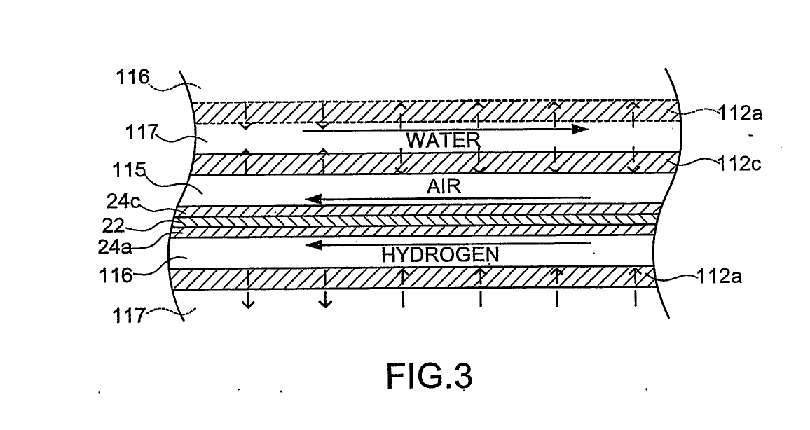

Next, referring to FIG. 3, flow directions in the air passage 115, the hydrogen passage 116, and the water passage 117 will be described. This drawing is a sectional view of the fuel cell 21 taken along the line III-III of FIG. 2. It should be noted that part of the adjacent fuel cell 21 is indicated by dotted lines. As shown in the drawings, the air in the air passage 115 and the hydrogen in the hydrogen passage 116 flow in the same direction, and the water in the water passage 117 flow in the opposite direction. The water flowing in the water passage 117 permeates through the wall of the plate 112c by capillary action and reaches the air passage 115. Dry air is supplied to the air passage 115, and the water reaching the air passage 115 is evaporated to humidify the dry air.

Further, the water flowing through the passage 117 permeates through the wall of the plate 112a of the adjacent fuel cell 21 by capillary action, and reaches the hydrogen passage 116 of the adjacent fuel cell 21. The water having reached the hydrogen passage 116 is evaporated to humidify the hydrogen in the hydrogen passage 116.

The fuel cell 21 generates water at the cathode gas diffusion electrode 24c by power generating reaction of hydrogen and oxygen through the solid polymer electrolyte membrane 22. The generated water reversely permeates through the plate 112c to flow into the water passage 117. At the anode gas diffusion electrode 24a, hydrogen is consumed in the power generating reaction, and the water used to humidify the hydrogen is condensed. The condensed water reversely permeates through the plate 112a of the adjacent fuel cell 21 to flow into the water passage 117 of the adjacent fuel cell 21.

In this way, inside the fuel cell 21, water circulates according to the condition of the power generating reaction. The fuel cell stack 1 is formed by stacking together a number of fuel cells 21 constructed as described above.

The air passage 115 of each fuel cell 21 in the stacked state communicates with the hydrogen pipe 10 through an air inflow manifold extending through the fuel cell stack 1 and with the air pressure control valve 5 through an air outflow manifold extending through the fuel cell stack 1 in parallel with the air inflow manifold. Similarly the hydrogen passage 116 in each fuel cell 21 in the stacked state communicates with the hydrogen pipe 12 and the hydrogen pressure control valve 6 through a hydrogen inflow manifold and a hydrogen outflow manifold, and the water passage 117 communicates with the upstream and downstream portions of the water pipe 11 through a water inflow manifold and a water outflow manifold.

The anode 1a of FIG. 1 generally refers to the anode gas diffusion electrode 24a, the plate 112a, and the hydrogen passage 116 of each of the fuel cells 21 stacked together as well as the hydrogen inflow and outflow manifolds.

Hydrogen flows through the anode 1a from an end portion 1aA to an end portion 1aB.

The cathode 1c of FIG. 1 generally refers to the cathode gas diffusion electrode 24c, the plate 112c, and the air passage 115 of each of the fuel cells 21 stacked together as well as the air inflow and outflow manifolds.

Air flows through the cathode 1c from an end portion 1cA to an end portion 1cB in parallel with the hydrogen. The water passage 1b of FIG. 1 generally refers to the water passage 117 of each of the fuel cells 21 stacked together as well as the water inflow and outflow manifolds. Water flows through the water passage 1c from an end portion 1bB to an end portion 1bB in a direction opposite to the flowing direction of the hydrogen and air.

Next, water control for the fuel cell stack 1 will be described. In the fuel cells 21, power generation is effected through the following reactions:
anode 1a: H₂→2H⁺+2e⁻
cathode 1c: 1/2O₂+2H⁺+2e⁻→H₂O

As is apparent from the above formulas, water vapor is generated at the cathode 1c. When the relative humidity of the air has reached 100%, and condensed water has been generated, the condensed water permeates through the plate 112c to enter the water passage 117, and joins the water flowing through the water passage 117 before being discharged from the fuel cell stack 1. It should be noted that for this phenomenon to occur, a predetermined difference in pressure is required between the air passage 115 and the water passage 117.

Although no water is generated at the anode 1a, in the hydrogen passages 116, water permeating through the plate 112a humidifies the hydrogen supplied from the fuel pump 18. While the hydrogen is consumed with the above reaction at the anode 1a, the water vapor is not consumed, with the result that the water vapor is gradually condensed. This condensed water permeates through the plate 112a to enter the water passage 117 of the adjacent fuel cell 21, and joins the water in the water passage 117 before being discharged from the fuel cell stack 1. It should be noted, however, that for this phenomenon to occur, a predetermined difference in pressure is required between the hydrogen passage 116 and the water passage 117 of each fuel cell 21.

As described above, exchange of water is effected between the water and air and between the water and hydrogen through the plates 112c and 112a, respectively. At the same time, as a result of the change in amount of substance due to the power generating reaction and humidification, pressure distribution is generated inside the passages 115, 116, and 117. To ensure a desirable circulation of water, it is necessary to control the difference in pressure between the water and air and the difference in pressure between the water and hydrogen so as to keep them within a predetermined permissible pressure difference range with respect to the entire passage region. However, it is rather difficult to perform fine control of the difference in pressure over the entire region of the passages 115, 116, and 117 of each fuel cell 21.

In this fuel cell system 20, the pressure difference between water and air and between water and hydrogen at the inlet and outlet of the water passage 1b are kept within a permissible pressure difference range Pₗᵢₘ, whereby the pressure difference between the passages 115 and 117 and between the passages 116 and 117 of each fuel cell 21 are maintained in a desirable state over the entire length of the passage.

Next, the construction of the fuel cell system 20 for realizing this control will be described.

The fuel cell system 20 is equipped with an air inlet pressure sensor 2a for measuring the pressure of air supplied to the cathode 1c, that is, the air inlet pressure P_{Ai}, a water outlet pressure sensor 3a for measuring the pressure of water flowing out of the water passage 1b, that is, the water outlet pressure P_{Wo}, and a hydrogen inlet pressure sensor 4a for measuring the pressure of hydrogen supplied to the anode 1a, that is, the hydrogen inlet pressure P_{Hi}.

The fuel cell system 20 is further equipped with a target output current setting unit 23 for generating a signal corresponding to a target output current It for the fuel cell stack 1. The target output current It is computed based on the required load for the fuel cell stack 1.

The fuel cell system 20 is equipped with a controller 13 for performing the above-mentioned pressure difference control for the fuel cell stack 1 based on these items of data. The controller 13 is formed by a microcomputer that has a central processing unit (CPU), a random access memory (RAM), a read-only memory (ROM), and input/output interface (I/O interface). It is also possible for the controller 13 to be formed by a plurality of microcomputers.

The controller 13 calculates a target hydrogen inlet pressure P_{Hti} that is the target supply pressure of hydrogen and a target air inlet pressure P_{Ati} that is the target supply pressure of air by using the target output current It and the output of the water outlet pressure sensor 3a. The controller 13 adjusts the air pressure control valve 5 and the hydrogen pressure control valve 6 according to the output of the air inlet pressure sensor 2a and the output of the hydrogen outlet pressure sensor 4a, thereby adjusting the difference in pressure between the reactive gas and humidifying water in the fuel cell stack 1 and, accordingly, the humidification amount of the reactive gas.

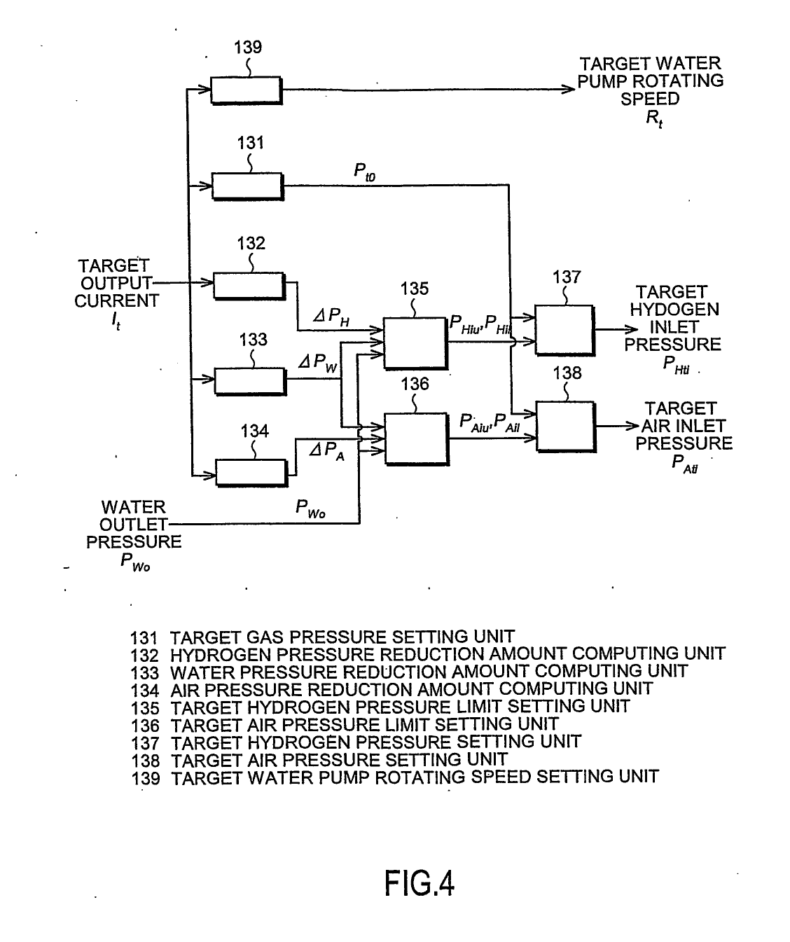

Next, referring to FIG. 4, the functions of the controller 13 for the above control will be described. In this block diagram, the functions of the controller 13 are illustrated as representing imaginary units. These units are shown solely for the purpose of conceptually illustrating the controls, and do not always exist physically.

The controller 13 is equipped with a target gas pressure setting unit 131. The target gas pressure setting unit 131 sets a target reactive gas pressure Pₜ₀ according to the target output current Iₜ. Further, the controller 13 is equipped with a hydrogen pressure reduction amount computing unit 132, a water pressure reduction amount computing unit 133, and an air pressure reduction amount computing unit 134 for respectively obtaining pressure reduction amounts ΔP_{H}, ΔP_{W}, and ΔP_{A} corresponding to the consumption amounts for power generation according to the target output current Iₜ.

Further, the controller 13 is equipped with a target hydrogen pressure limit setting unit 135 for calculating an upper limit value P_{Hiu}, and a lower limit value P_{Hil} of the target hydrogen inlet pressure P_{Hti}, and a target air pressure limit setting unit 136 for calculating an upper limit value P_{Aiu} and a lower limit value P_{Ail} of the target air inlet pressure P_{Ati}. The method of calculating the upper limit values P_{Hiu} and P_{Aiu}, and the lower limit values P_{Hil} and P_{Ail} will be described below.

The controller 13 is further equipped with a target hydrogen pressure setting unit 137 for calculating the target hydrogen inlet pressure P_{Hit} from the target reactive gas pressure Pₜ₀, the upper limit value P_{Hiu}, and the lower limit value P_{Hil}, and a target air pressure setting unit 138 for calculating the target air inlet pressure P_{Ati} from the target reactive gas pressure Pₜ₀, the upper limit value P_{Aiu}, and the lower limit value P_{Ail}. Further, the controller 13 is equipped with a target water pump rotating speed setting unit 139 for calculating the target water pump rotating speed Rₜ according to the target output current Iₜ.

Next, the control of the rotating speed Rₜ of the water pump 7 will be described.

The controller 13 sets a required water flow rate for maintaining the fuel cell stack 1 at an appropriate temperature as the target rotating speed Rₜ of the water pump 7, according to the target output current Iₜ.

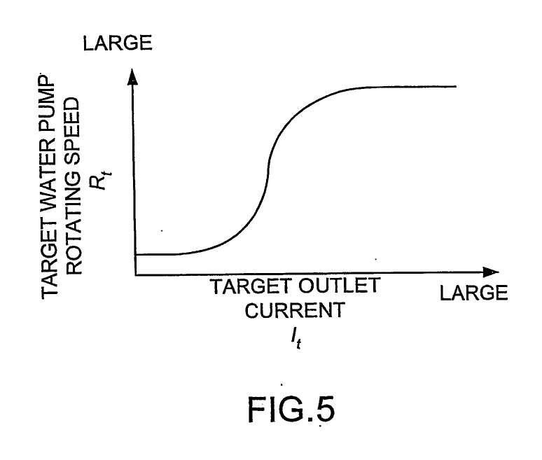

For this purpose, a map of the target rotating speed Rₜ having characteristics shown in FIG. 5 is previously stored in the target water pump rotating speed setting unit 139. Referring to this map, the controller 13 obtains the target water pump rotating speed Rₜ from the target output current Iₜ, and controls the operation of the water pump 7 such that the target water pump rotating speed Rt is achieved.

Next, the method of controlling the difference in pressure between the air and the water, and the hydrogen and the water will be described. In the following description, a gas pressure P_{G} refers to both the hydrogen gas pressure P_{H} and the air pressure P_{A}.

First, the permissible pressure difference range Pₗᵢₘ is set previously by experiment. More specifically, a minimum value ΔPₘᵢₙ of the difference in pressure between the humidifying water pressure P_{W} and the gas pressure P_{G} , P_{G}−P_{W}, is set so as to be equal to the humidification limit pressure difference of the reactive gas. When the pressure difference between the gas pressure P_{G} and the humidifying water pressure P_{W} becomes smaller than the humidification limit pressure difference, it is determined that condensed water has been generated in the gas passages 115 or 116.

It should be noted that water permeates through the wall of the plate 112a, 112c by capillary action while the pressure in the air passage 115 and hydrogen passage 116 is higher than the pressure in the water passage 117. The permeating amount however depends on the pressure difference between the water passage 117 and air passage 115 or that between the water passage 117 and hydrogen passage 116. The smaller the pressure difference, the larger the permeating amount is.

Next, a maximum value AΔPₘₐₓ of the difference in pressure P_{G}−P_{W} is set so as to be equal to the humidification deficiency limit pressure difference of the reactive gas. When the pressure difference between the gas pressure P_{G} and the humidifying water pressure P_{W} becomes larger than the humidification deficiency limit pressure difference, it is determined that humidifying water may not reach the gas passages 115 or 116. In other words, it is the pressure difference at which it is determined that reactive gas may leak into the water passage 117. It is to be assumed that the permissible pressure difference range Pₗᵢₘ should not be lower than ΔPₘᵢₙ but not higher than ΔPₘₐₓ.

The controller 13 performs pressure adjustment such that the difference in pressure between the air passage 115 and the humidifying water passages 117 and the difference in pressure between the hydrogen passage 116 and the humidifying water passages 117 are both within the permissible pressure difference range Pₗᵢₘ, thereby appropriately humidifying the reactive gas.

To realize this condition, the controller 13 controls the difference in pressure between a reactive gas inlet pressure P_{Gi} and the water outlet pressure P_{Wo}, P_{Gi}−P_{Wo}, and the difference in pressure between a gas outlet pressure P_{Go} and the water inlet pressure P_{Wi}, P_{Go}−P_{Wi}, so as to keep them both within the permissible pressure difference range Pₗᵢₘ.

For this purpose, the controller 13 first calculates the pressure at either the inlet or the outlet of which no measurement has been performed by the following equations (1) and (2), using the water pressure reduction amount ΔP_{W} that corresponds to the water amount used for the humidification of the reactive gas and the gas reduction amount ΔP_{G} that corresponds to the reactive gas amount consumed in the power generation in the fuel cell stack 1.
P_{Wi}=P_{Wo}+ΔP_{W} (1)
P_{Go}=P_{Gi}−ΔP_{G} (2)

Taking into consideration the maximum value ΔPₘₐₓ and the minimum value ΔPₘᵢₙ of the above-mentioned pressure difference, it is necessary for the pressure difference P_{Gi}−P_{Wo} to be maintained within the range of the following formula (3):
ΔPₘᵢₙ≦P_{Gi}−P_{Wo}≦ΔPₘₐₓ (3)

By transforming formula (3), formula (4) is obtained.
P_{Wo}+ΔPₘᵢₙ≦P_{Gi}≦P_{Wo}+ΔPₘₐₓ (4)

It is necessary for the pressure difference P_{Go}−P_{Wi} to be maintained within the range of the following formula (5):
ΔPₘᵢₙ≦P_{Go}−P_{Wi}≦ΔPₘₐₓ (5)

By transforming formula (5), formula (6) is obtained.
P_{Wi}+ΔPₘᵢₙ+ΔP_{G}≦P_{Gi}≦P_{Wi}+ΔPₘₐₓ+ΔP_{G}. (6)

The condition satisfying both formulae (4) and (6) can be expressed by the following formula (7):
P_{Wi}+ΔPₘᵢₙ+ΔP_{G}≦P_{Gi}≦P_{Wo}+ΔPₘₐₓ (7)

Thus, the upper limit value P_{Giu} of the gas inlet pressure P_{Gi} can be expressed by the following equation (8):
P_{Gil}=P_{Wo}+ΔPₘₐₓ (8)

The lower limit value P_{Gil} of the gas inlet pressure P_{Gi} can be expressed by the following equation (9):
P_{Gil}=P_{Wi}+ΔPₘᵢₙ+ΔP_{G} (9)

By using equation (1), equation (9) may be expressed by the following equation (10):
P_{Gil}=P_{Wo}+ΔPₘᵢₙ+ΔP_{G}+ΔP_{W} (10)

By controlling the gas inlet pressure P_{Gi} so as to keep it between the lower limit value and the upper limit value, it is possible to appropriately control the pressure difference between the humidifying water and the reactive gas.

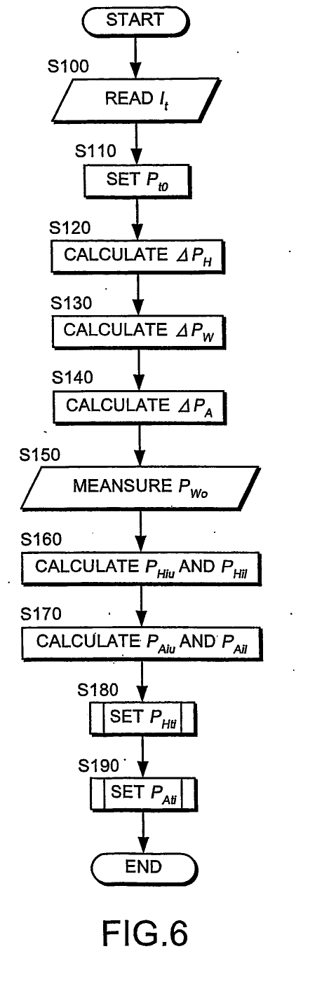

Next, referring to FIG. 6, a gas pressure control routine executed by the controller 13 will be described. This routine is repeatedly executed for each predetermined time after the start of the operation of the fuel cell system 20 until the completion thereof. Here, it is to be assumed that the predetermined time is one second. It is also possible to execute the routine when there is any change in the target output current Iₜ.

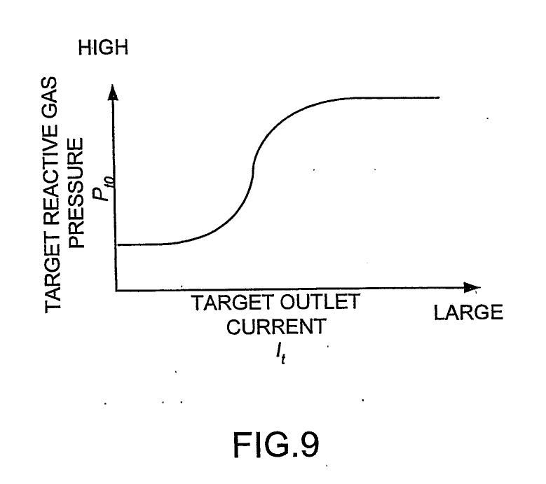

In a step S100, the controller 13 reads the target output current Iₜ output from the target output current setting unit 23. In a step S110, the controller 13 sets the target reactive gas pressure Pₜ₀ from the target output current Iₜ. For this setting, the ROM of the controller 13 previously stores a map defining the relationship between the target output current Iₜ and the corresponding target reactive gas pressure Pₜ₀ having characteristics shown in FIG. 9. The controller 13 searches this map to obtain the target reactive gas pressure Pₜ₀ of the fuel cell stack 1 from the target output current Iₜ. The target output current Iₜ corresponds to the load of the fuel cell stack 1. Steps S100 and S110 correspond to the target gas pressure setting unit 131 of FIG. 4.

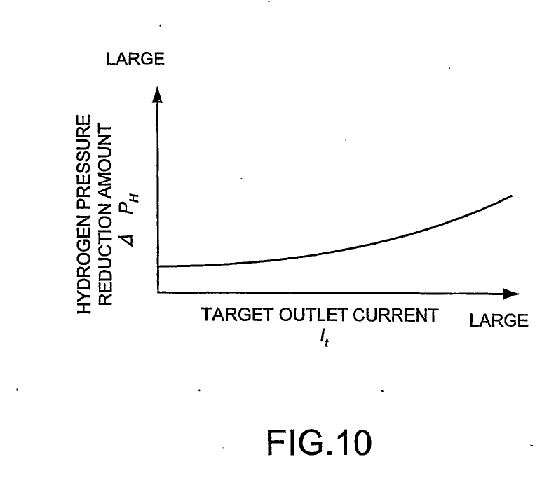

Next, in a step S120, the controller 13 obtains the hydrogen pressure reduction amount ΔP_{H} in the fuel cell stack 1 according to the target output current Iₜ. The pressure reduction amount ΔP_{H} is the hydrogen pressure reduction amount as a result of the consumption of hydrogen through the power generating reaction in the fuel cell stack 1. For this computation, a map of the pressure reduction amount ΔP_{H} of the characteristic shown in FIG. 10 is previously stored in the ROM of the controller 13. The controller 13 searches this map to obtain the hydrogen pressure reduction amount ΔP_{H} in the fuel cell stack 1 from the target output current Iₜ.

The step 120 corresponds to the hydrogen pressure reduction amount computing unit 132 of FIG. 4.

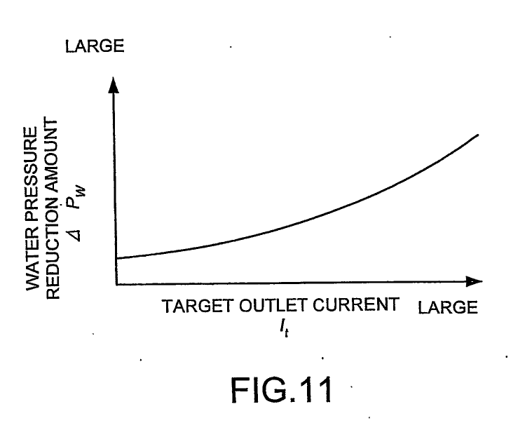

In a next step S130, the controller 13 obtains the water pressure reduction amount ΔP_{W} in the fuel cell stack 1 according to the target output current Iₜ. The pressure reduction amount ΔP_{W} is the water pressure reduction amount due to the humidification of the reactive gas in the fuel cell stack 1. For this computation, a map of the water pressure reduction amount ΔP_{W} of the characteristic shown in FIG. 11 is previously stored in the ROM of the controller 13. The controller 13 searches this map to obtain the water pressure estimation amount ΔP_{W} in the fuel cell stack 1 from the target output current Iₜ.

The step S130 corresponds to the water pressure reduction amount computing unit 133 of FIG. 4.

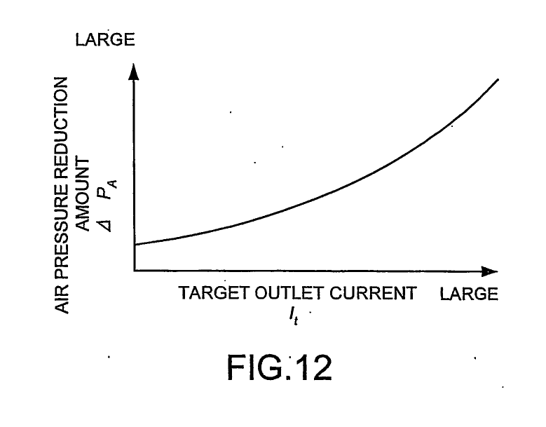

In a next step S140, the controller 13 obtains the air pressure reduction amount ΔP_{A} in the fuel cell stack 1 according to the target output current Iₜ. The pressure reduction amount ΔP_{A} is a reduction in air pressure due to the amount of oxygen consumed by the power generating reaction in the fuel cell stack 1. For this computation, a map of the air pressure reduction amount ΔP_{A} of the characteristic shown in FIG. 12 is previously stored in the ROM of the controller 13. The controller 13 searches this map to obtain the air pressure reduction amount ΔP_{A} in the fuel cell stack 1 from the target output current Iₜ.

The step 140 corresponds to the air pressure reduction amount computing unit 134 of FIG. 4.

In a next step S150, the controller 13 reads the water outlet pressure P_{Wo} detected by the water outlet pressure sensor 3a. In a step S160, the controller 13 calculates the upper limit value P_{Hil}, and the lower limit value P_{Hil} of the target hydrogen inlet pressure P_{Hti} by using the above equations (8) and (10). Here, taking into account the measurement error and control error, the upper limit value P_{Hiu} and the lower limit value P_{Hil} are calculated by the following equations (11) and (12) derived from equations (8) and (10).
P_{Hiu}=P_{Wo}−(sensor error allowance)+ΔPₘₐₓ−(hydrogen pressure control error allowance ) (11)
P_{Hil}=P_{Wo}+(sensor error allowance)+ΔPₘᵢₙ+ΔP_{H}+ΔP_{W}+(hydrogen pressure control error allowance) (12)

The step 160 corresponds to the target hydrogen pressure limit setting unit 135 of FIG. 4.

Further, in a step S170, the controller 13 calculates the upper limit value P_{Aiu} and the lower limit value P_{Ail} of the target air inlet pressure P_{Ati} through a process similar to that of the step S160 by using the following equations (13) and (14).
P_{Aiu}=P_{Wo}−(sensor error allowance )+ΔPₘₐₓ−(air pressure control error allowance) (13)
P_{Ail}=P_{Wo}+(sensor error allowance )+ΔPₘᵢₙ+ΔP_{A}+ΔP_{W}+(air pressure control error allowance) (14)

The step 170 corresponds to the target air pressure limit setting unit 136 of FIG. 4.

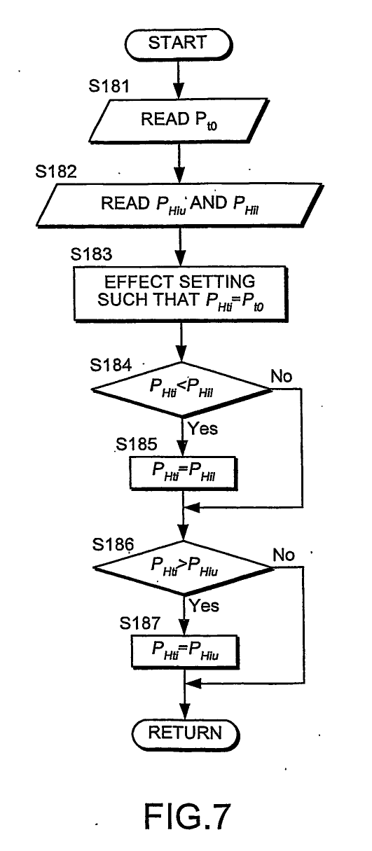

In a next step S180, the controller 13 sets the target hydrogen inlet pressure P_{Hti} by using the subroutine as shown in FIG. 7.

The step 180 corresponds to the target hydrogen pressure setting unit 137 of FIG. 4.

Referring now to FIG. 7, the controller 13 reads, in a step S181, the target reactive gas pressure Pₜ₀ obtained in the step S110 of FIG. 6. In a next step S182, the controller 13 reads the upper limit value P_{Hiu} and the lower limit value P_{Hil} of the target hydrogen inlet pressure P_{Hti} obtained in the step S160 of FIG. 6. In a next step S183, the controller 13 sets the target hydrogen inlet pressure P_{Hti} to the target reactive gas pressure Pₜ₀.

Next, in a step S184, the controller 13 determines whether or not the target hydrogen inlet pressure P_{Hti} is lower than the lower limit value P_{Hil}. When the target hydrogen inlet pressure P_{Hti} is lower than the lower limit value P_{Hil}, the controller 13, in a step 5185, sets the target hydrogen inlet pressure P_{Hti} to the lower limit value P_{Hil}. After the processing in the step S185, the controller 13 executes the processing of a step S186.

On the other hand, when the target hydrogen inlet pressure P_{Hti} is not lower than the lower limit value P_{Hil} in the step S184, the controller 13 skips the step S185 and executes the processing of the step S186.

In the step 186, the controller 13 determines whether or not the target hydrogen inlet pressure P_{Hti} is higher than the upper limit value P_{Hiu}. When the target hydrogen inlet pressure P_{Hti} is higher than the upper limit value P_{Hiu}, the controller 13, in a step 187, sets the target hydrogen inlet pressure P_{Hti} to the upper limit value P_{Hiu}. After the processing in the step S187, the controller 13 terminates the subroutine.

On the other hand, when, in the step S186, the target hydrogen inlet pressure P_{Hti} is not higher than the upper limit value P_{Hiu}, the controller 13 terminates the subroutine without executing the processing of the step S187.

Through the execution of this subroutine, when the target reactive gas pressure Pₜ₀ is within the limit range, that is, when P_{Hil}≦Pₜ₀≦P_{Hiu}, the target hydrogen inlet pressure P_{Hti} is set to be equal to the target reactive gas pressure Pₜ₀. When Pₜ₀>P_{Hiu}, the target hydrogen inlet pressure P_{Hti} is set to be equal to the upper limit value P_{Hiu}. When Pₜ₀<P_{Hil}, the target hydrogen inlet pressure P_{Hti} is set to be equal to the lower limit value P_{Hil}.

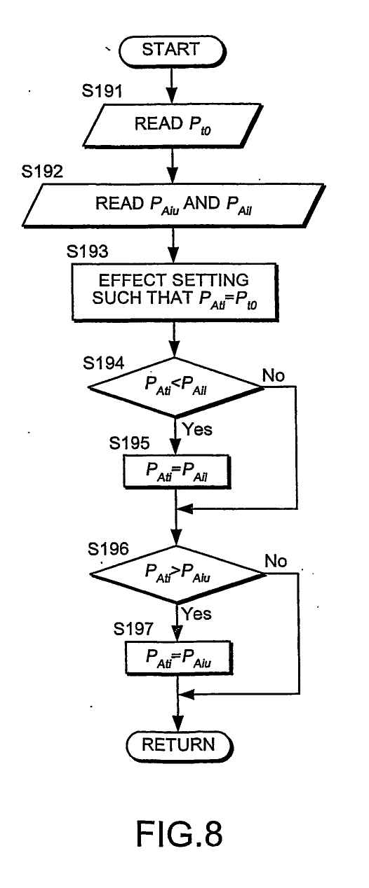

Now referring back to FIG. 6, after setting the target hydrogen inlet pressure P_{Hti} in the step S180, the controller 13 sets, in a step S190, the target air inlet pressure P_{Ati} by using a subroutine shown in FIG. 8.

The step S190 corresponds to the target air pressure setting unit 138 in FIG. 4. The subroutine of FIG. 8 corresponds to the subroutine of FIG. 7 where the hydrogen pressure is replaced by air pressure.

The controller 13 reads, in a step S191, the target reactive gas pressure Pₜ₀ obtained in the step S110, and reads, in a step S192, the upper limit value P_{Aiu} and the lower limit value P_{Ail} of the target air inlet pressure P_{Ati} obtained in the step S170. In a step S193, setting is made such that the target air inlet pressure P_{Ati} is equal to the target reactive gas pressure Pₜ₀.

In a next step S194, the controller 13 determines whether or not the target air inlet pressure P_{Ati} is lower than the lower limit value P_{Ail}. When the determination is affirmative, the controller 13, in a step 195, sets the target air inlet pressure P_{Ati} to the lower limit value P_{Ail}. After the processing in the step S195, the controller 13 executes the processing of a step S196. When the determination is negative, the controller 13 skips the step S195 and executes the processing of the step S196.

In the step S196, the controller 13 determines whether or not the target air inlet pressure P_{Ati} is higher than the upper limit value P_{Aiu}.

When the determination is affirmative, the controller 13, in a step 197, sets the target air inlet pressure P_{Ati} to the upper limit value P_{Aiu}. After the processing in the step S197, the controller 13 terminates the subroutine. When the determination in the step S196 is negative, the controller 13 terminates the subroutine without executing the processing of the step S197.

Through the execution of this subroutine, when the target reactive gas pressure Pₜ₀ is within the permissible range, that is, when P_{Ail}≦Pₜ₀≦P_{Aiu}, the target air inlet pressure P_{Ati} is set to be equal to the target reactive gas pressure Pₜ₀. When Pₜ₀>P_{Aiu}, the target air inlet pressure P_{Ati}, is set to be equal to the upper limit value P_{Aiu}. When Pₜ₀<P_{Ail}, the target air inlet pressure P_{Ati} is set to be equal to the lower limit value P_{Ail}.

With the termination of the subroutine of FIG. 8, the processing in the step S190 of the routine of FIG. 6 is terminated. After the processing in the step S190, the controller 13 terminates the routine. In order to realize the target hydrogen inlet pressure P_{Hti}, the controller 13 monitors the hydrogen inlet pressure P_{Hi} detected by the hydrogen inlet pressure sensor 4a, and feedback-controls the hydrogen pressure control valve 6. Similarly, in order to realize the target air inlet pressure P_{Ati}, the controller 13 feedback-controls the air pressure control valve 5 while monitoring the air inlet pressure P_{Ai} detected by the air inlet pressure sensor 2a.

As described above, in this fuel cell system 20, the controller 13 calculates the target reactive gas pressures P_{Hti} and P_{Ati} according to the humidifying water pressure P_{Wo} and the target output current Iₜ of the fuel cell stack 1, and controls the hydrogen pressure control valve 6 and the air pressure control valve 5 according to the target reactive gas pressures P_{Hti} and P_{Ati}, whereby it is possible to control, in correspondence with various electrical loads on the fuel cell stack 1, the degree to which the reactive gases of the fuel cell stack 1 are humidified.

Further, since the target gas pressures P_{Ati} and P_{Hti} are controlled by means of the upper and lower limit values, it is possible to prevent the reactive gas from leaking into the water passage 117 through the plate 112c or 112a. Further, it is also possible to prevent generation of flooding due to excessive humidification of the reactive gas.

While in this fuel cell system 20 the water passage 117 are formed in the plate 112c of each fuel cell 21, it is also possible to form the water passage 117 in the plate 112a. Further, it is also possible to form the water passage 117 in a groove like shape on the surface of a nonporous member and cover the opening by a porous member.

Further, while in this fuel cell system 20 the control of the water pump 7 is performed separately from the reactive gas pressure control routine of FIG. 6, it is also possible to provide after the step S140 a step for setting the load of the water pump 7 and to include the control of the water pump 7 in this routine. In this case, instead of measuring the water outlet pressure P_{Wo} in the step S150, a pressure corresponding to the target water flow rate obtained from the target output current It is used as the water outlet pressure P_{Wo}.

In this fuel cell system 20, the target gas inlet pressures P_{Hti} and P_{Ati} are obtained in order to control the hydrogen pressure control valve 6 and the air pressure control valve 5. Instead of the target gas inlet pressures P_{Hti} and P_{Ati}, it is also possible to obtain the target gas outlet pressures P_{Hto} and P_{Ato}, controlling the hydrogen pressure control valve 6 and the air pressure control valve 5 such that the target gas outlet pressures P_{Hto} and P_{Ato} are realized. In this case, it is necessary to obtain a limit range for the gas outlet pressure P_{Go}. The upper limit value P_{Gou} and the lower limit value P_{Goi} are set by the following equations (15) and (16):
P_{Gou}=P_{Wo}−(sensor error allowance )+ΔPₘₐₓ−ΔP_{G}−(gas pressure control error allowance) (15)
P_{Goi}=P_{Wo}+(sensor error allowance )+ΔPₘᵢₙ+ΔP_{W}+(hydrogen pressure control error allowance) (16)

While the water outlet pressure P_{Wo} is measured in this fuel cell system 20, it is also possible to measure the water inlet pressure P_{Wi} instead of the water outlet pressure P_{Wo}. In this case, the water outlet pressure P_{Wo} is calculated by the following equation (17):
P_{Wo}=P_{Wi}−ΔP_{W} (17)

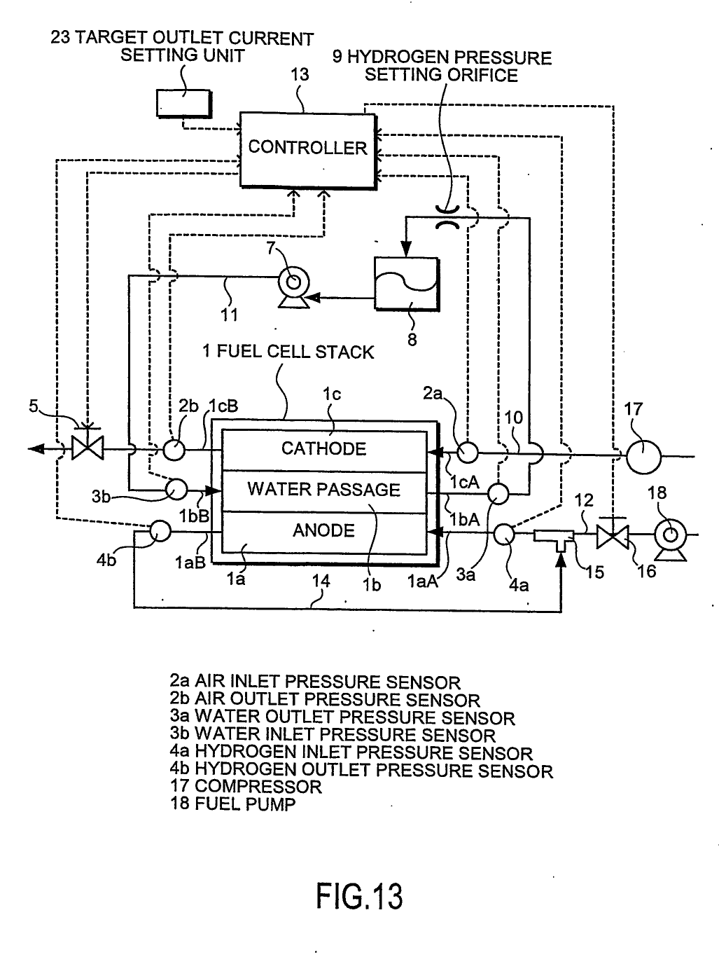

Next, referring to FIGS. 13 through 15, a second embodiment of this invention will be described. In the second embodiment, the supply of hydrogen to the anode 1a of the fuel cell stack 1 is effected by the following circulation system.

Referring to FIG. 13, the fuel cell system 20 of the second embodiment is equipped with a hydrogen recirculation passage 14 and an ejector 15. The hydrogen recirculation passage 14 returns unused hydrogen discharged from the fuel cell stack 1 to the hydrogen pipe 12 through the ejector 15, and use it again for power generation. The adjustment of the hydrogen pressure at the anode 1a is effected by a hydrogen pressure control valve 16 provided in the portion of the hydrogen pipe 12 on the upstream side of the ejector 15. By the hydrogen pressure control valve 16, the difference in pressure between the hydrogen supplied and the hydrogen recirculated to thereby control the pressure in the anode 1a.

Generally speaking, in the fuel cell system 20, when a large output current is to be drawn out of the fuel cell stack 1, the pressures of the hydrogen and air supplied to the fuel cell stack 1 are set high. Conversely, when the output is to be small, the pressures of the gases supplied to the fuel cell stack 1 are set low. However, in the fuel cell system 20 equipped with the hydrogen recirculation passage 14, the following problem is involved when abruptly reducing the output current of the fuel cell stack 1.

As shown in FIG. 9, when the output from the fuel cell stack 1 is to be reduced, the pressures of the hydrogen and air supplied to the fuel cell stack 1 are lowered. The supply of hydrogen to the anode 1a is accompanied by the recirculation of hydrogen by the hydrogen recirculation passage 14. In order to lower the pressure of the hydrogen in the anode 1a, it is necessary to first close the hydrogen pressure control valve 16 and wait until the recirculated hydrogen to the anode 1a is consumed through power generation by the fuel cell stack 1.

However, reducing the output current of the fuel cell stack 1 means a reduction in the hydrogen consumption amount of the anode 1a, so the reduction in the pressure of the hydrogen supplied to the anode 1a occurs very slowly.

When, in contrast, the rotating speed of the water pump 7 is set by the map of the characteristic as shown in FIG. 5, the hydrogen pressure P_{H} at the anode 1a tends to be excessively high as compared to the water pressure P_{W} set according to the output current of the fuel cell stack 1.

In order to suppress such a tendency, the variation of the water flow rate is restricted depending on the variation of the gas pressure P_{G}, in particular, the hydrogen pressure P_{H}, thereby maintaining an appropriate pressure difference between the hydrogen pressure P_{H} and the water pressure P_{W}.

In order to realize this control, the fuel cell system 20 according to this embodiment is further equipped, apart from the sensors of the first embodiment, with an air outlet pressure sensor 2b, a water inlet pressure sensor 3b, and a hydrogen outlet pressure sensor 4b.

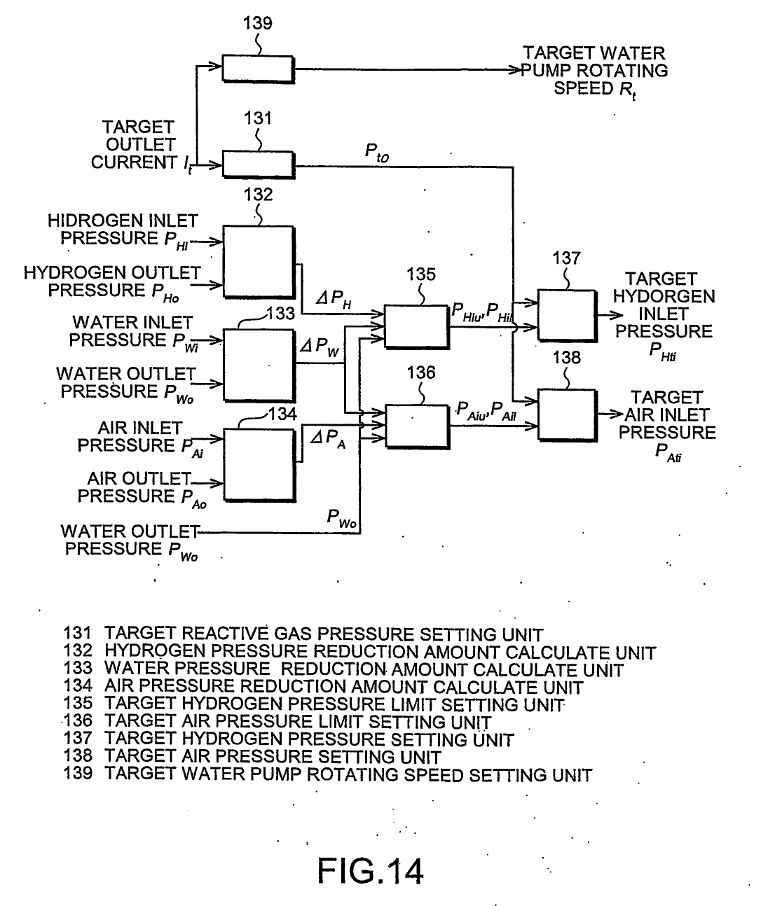

The controlling functions of the controller 13 are configured as shown in FIG. 14.

Referring to FIG. 14, while the functions of the unit 131 and the units 135 through 138 are the same as those of the first embodiment, the hydrogen pressure reduction amount computing unit 132, the water pressure reduction amount computing unit 133, and the air pressure reduction amount computing unit 134 of this embodiment are differently configured from the first embodiment.

The hydrogen pressure reduction amount computing unit 132 calculates the pressure difference between the pressure P_{Hi} detected by the hydrogen inlet pressure sensor 4a and the pressure P_{Ho} detected by the hydrogen outlet pressure sensor 4b as the hydrogen pressure reduction amount ΔP_{H}. The water pressure reduction amount computing unit 133 calculates the pressure difference between the pressure P_{Wi} detected by the water inlet pressure sensor 3b and the pressure P_{Wo} detected by the water outlet pressure sensor 3a as the water pressure reduction amount ΔP_{W}. The air pressure reduction amount computing unit 134 calculates the pressure difference between the pressure P_{Ai} detected by the air inlet pressure sensor 2a and the pressure P_{Ao} detected by the air outlet pressure sensor 2b as the air pressure reduction amount ΔP_{A}.

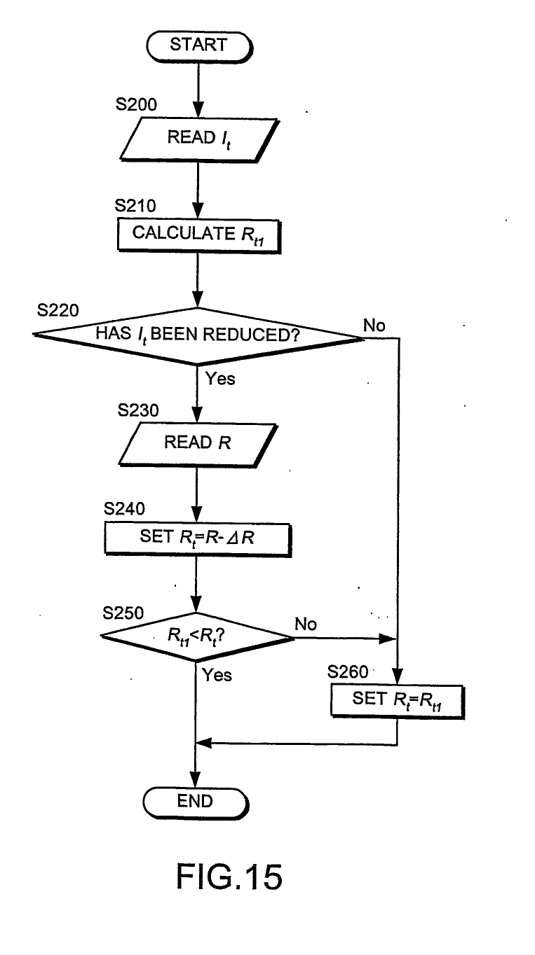

As in the first embodiment, by using the above functions, the controller 13 calculates the target, hydrogen inlet pressure P_{Hti} and the target air inlet pressure P_{Ati} according to the routine of FIG. 6, and controls the hydrogen pressure control valve 16 and the air pressure control valve 5. Further, the controller 13 executes a routine shown in FIG. 15 to adapt the water supply flow rate to the varying pressure P_{H} of the hydrogen supplied to the anode 1a. This routine corresponds to the function of the target water pump rotating speed setting unit 139 of FIG. 14, and is executed under the same condition as the routine of FIG. 6.

Referring to FIG. 15, the controller 13 first reads, in a step S200, the target output current Iₜ as set by the target output current setting unit 23. In a next step S210, the controller 13 searches a map of the characteristic shown in FIG. 5 to obtain from the target output current Iₜ a target rotating speed Rₜ₁ of the water pump 7 corresponding to the target output current.

In a next step S220, the controller 13 compares the target output current Iₜ with the target output current Iₜₙ₋₁ at the time of the previous execution of the routine to thereby determine whether or not the target output current Iₜ has been reduced. When it is determined that the target output current Iₜ has been reduced, the controller 13 reads, in a step S230, a current rotating speed R of the water pump 7.

Next, in a step S240, the controller 13 calculates the target water pump rotating speed R. Herein, it is defined that the value obtained by subtracting a predetermined value ΔR from the current water pump rotating speed R, i.e., (R−ΔR), is the target water pump rotating speed Rₜ.

The predetermined value ΔR is a fixed value corresponding to the pressure reduction speed of the anode 1a when the generation current of the fuel cell stack 1 changes from maximum current to minimum current. Alternatively, it is assumed that it is a value corresponding to the maximum reduction speed of the hydrogen pressure of the anode 1a. In this case, when the maximum reduction speed of the hydrogen pressure of the anode 1a is high, ΔR is large.

As a result, the reduction speed of the water pressure is high. The value of ΔR is previously set by experiment.

In a next step S250, the controller 13 compares the target water pump rotating speed Rₜ with the rotating speed Rₜ₁ corresponding to the target output current Iₜ obtained in the step S210. When the target water pump rotating speed Rₜ is higher than the rotating speed Rₜ₁ corresponding to the target output current, the controller 13 terminates the routine without correcting the target water pump rotating speed Rₜ.

On the other hand, when, in the step S220, the target output current Iₜ has not been reduced, or when, in the step S250, it is determined that the target water pump rotating speed Rₜ is not higher than the rotating speed Rₜ₁ corresponding to the target output current, the controller 13 sets, in a step S260, the target water pump rotating speed Rₜ to the target water pump rotating speed Rₜ₁ corresponding to the target output current. After the processing of the step S260, the controller 13 terminates the routine.

In this way, the reduction amount of the target rotating speed of the water pump 7 for each routine execution is suppressed to equal to or less than ΔR, whereby the pressure difference between the hydrogen pressure and the water pressure of the anode 1a is ensured within an appropriate range even when there is a large reduction in the generation current of the fuel cell stack 1.

The contents of Tokugan 2003-314283 with filing data of Sep. 5, 2003 in Japan are hereby incorporated by reference.

Although the invention has been described above by reference to certain embodiments of the invention, the invention is not limited to the embodiments described above. Modifications and variation of the embodiments described above will occur to those skilled in the air, within the scope of the claims.

While in the above embodiments both the hydrogen and air are humidified, this invention is also applicable to a fuel cell system in which only one of the hydrogen and air is humidified.

Further, instead of calculating the target reactive gas pressure Pₜ₀ according to the target output current It, it is also possible to calculate some other parameter representing the power generation load of the fuel cell stack 1, for example, the target gas pressure P_{Gt} based on the target power generation amount.

Further, while in the above embodiments the air and hydrogen flow in the same direction inside the fuel cell 21, and the water flows in the opposite direction, this invention can be carried out regardless of the way the flowing directions of the gases and water are set.

Further, while in the above embodiments the controller 13 and the target output current setting unit 23 are provided separately, it is also possible for the controller 13 to be endowed with a function by which it sets the target output current Iₜ.

While in the above embodiments the requisite parameters for control are detected by mean of sensors, there are no particular limitations in this invention regarding the way the parameters are obtained; any fuel cell system executing the control as claimed by using the claimed parameters is covered by the technical scope of this invention.

### INDUSTRIAL FIELD OF APPLICATION

This invention, which ensures a preferable humidification of the fuel cells irrespective of the power generation load, can provide a particularly desirable effect when applied to a vehicle-mounted fuel cell system which generally has a large variation in the power generation load.

The embodiment of this invention in which an exclusive property or privilege is claims are defined as follow:

1-13. (canceled)

14. A fuel cell system comprising a fuel cell stack effecting power generation upon supply of a reactive gas, the fuel cell stack comprising a reactive gas passage and a water passage substantially parallel to the reactive gas passage, the reactive gas passage and the water passage being separated by a porous member, the reactive gas being humidified by water permeating through the porous member, the fuel cell system comprising:
a reactive gas pressure control valve which controls a reactive gas pressure supplied to the reactive gas passage;
a water pressure sensor which detects a water pressure in the water passage; and
a programmable controller programmed to:
calculate a pressure reduction amount in the reactive gas passage based on a power generation load of the fuel cell stack;
calculate a pressure reduction amount in the water passage based on the power generation load of the fuel cell stack;
calculate, from the pressure reduction amount in the water passage and the pressure reduction amount in the reactive gas passage, a target pressure of the reactive gas supplied to the reactive gas passage such that a pressure difference between the reactive gas passage and the water passage is within a predetermined range; and
control the reactive gas pressure control valve based on the target pressure.

15. The fuel cell system as defined in claim 14, wherein the predetermined range is set to a pressure difference range which allows the water in the water passage to permeate through the porous member to the reactive gas passage while preventing condensation of water in the reactive gas passage.

16. The fuel cell system as defined in claim 14, wherein the fuel cell system further comprises a pump which supplies water to the water passage, and the controller is further programmed to control a rotating speed of the pump according to the power generation load of the fuel cell stack.

17. The fuel cell system as defined in claim 16, wherein the controller is further programmed to prevent the rotating speed of the pump from decreasing at a rate larger than a predetermined rate when the power generation load of the fuel cell stack decreases.

18. The fuel cell system as defined in claim 14, wherein the fuel cell system further comprises a gas pressure sensor which detects a pressure of the reactive gas supplied from the reactive gas pressure control valve to the reactive gas passage, and the controller is further programmed to control the reactive gas pressure control valve to cause the pressure detected by the gas pressure sensor to coincide with the target pressure of the reactive gas.

19. The fuel cell system as defined in claim 14, wherein the reactive gas passage comprises a first gas passage end and a second gas passage end, the water passage comprises a first water passage end in the vicinity of the first gas passage end and a second water passage end in the vicinity of the second gas passage end, and the controller is further programmed to determine a target pressure of the reactive gas supplied to the reactive gas passage to cause a pressure difference between a pressure at the first gas passage end and a pressure at the first water passage end and a pressure difference between a pressure at the second gas passage end to be both within a predetermined range.

20. The fuel cell system as defined in claim 19, wherein the reactive gas is supplied from the first gas passage end to the reactive gas passage, and the water is supplied from the second water passage end to the water passage.

21. The fuel cell system as defined in claim 20, wherein the water pressure sensor (3a, 3b) is a sensor (3a) which detects a pressure at the first water passage end (1bA).

22. The fuel cell system as defined in claim 21, wherein the controller is further programmed to calculate a required pressure of the reactive gas based on the power generation load of the fuel cell stack, calculate, from the pressure reduction amount in the water passage, and the pressure reduction amount in the reactive gas passage, a target pressure range of the reactive gas supplied to the reactive gas passage such that the difference in pressure between the reactive gas passage and the water passage is within a predetermine range, and calculate the target pressure by limiting the required pressure within the target pressure range.

23. The fuel cell system as defined in claim 22, wherein the controller is further programmed to determine the target pressure range by an upper limit value P_{Gu} and a lower limit value P_{Gl} determined by the following equations:
P_{Gu}=P_{Wo}+ΔPₘₐₓ
P_{Gl}=P_{Wi}+ΔPₘᵢₙ+ΔP_{G}
where, P_{Wo}=the pressure at the first water passage end (1bA);
ΔPₘₐₓ=a maximum pressure difference with which the water in the water passage can permeate through the porous member to reach the reactive gas passage;
P_{Wi}=the pressure at the second water passage end=P_{Wo}+ΔP_{W};
ΔP_{W}=the pressure reduction amount in the water passage;
ΔPₘᵢₙ=a minimum pressure difference which causes no water condensation in the reactive gas passage; and
ΔP_{G}=the pressure reduction amount in the reactive gas passage.

24. The fuel cell system as defined in claim 14, wherein the reactive gas comprises hydrogen.

25. The fuel cell system as defined in claim 14, wherein the reactive gas passage comprises an air passage, the reactive gas pressure control valve comprises an air pressure control valve which controls an air pressure supplied to the air passage, and the controller is further programmed to calculate a pressure reduction amount in the air passage based on the power generation load of the fuel cell stack, calculate, from the pressure reduction amount in the water passage and the pressure reduction amount in the air passage, a target pressure of air supplied to the air passage such that a pressure difference between the air passage and the water passage is within a predetermined range, and control the air pressure control valve based on the target pressure of air supplied to the air passage.

26. The fuel cell system as defined in claim 19, wherein the water pressure sensor comprises a sensor which detects a pressure at the first water passage end and a sensor which detects a pressure at the second water passage end, the fuel cell system further comprises a recirculation passage which recirculates reactive gas discharged from the second gas passage end to the first gas passage end, the fuel cell system further comprises a sensor which detects a gas pressure at the first gas passage end, a sensor which detects a gas pressure at the second gas passage end, and the controller is further programmed to calculate the pressure reduction amount in the water passage from the difference between the pressure at the second water passage end and the pressure at the first water passage end, and calculate the pressure reduction amount in the reactive gas passage from the difference between the gas pressure at the first gas passage end and the gas pressure at the second gas passage end.

27. A fuel cell system comprising a fuel cell stack effecting power generation upon supply of a reactive gas, the fuel cell stack comprising a reactive gas passage and a water passage substantially parallel to the reactive gas passage, the reactive gas passage and the water passage being separated by a porous member, the reactive gas being humidified by water permeating through the porous member, the fuel cell system comprising:
first means for controlling a reactive gas pressure supplied to the reactive gas passage;
second means for determining a water pressure in the water passage;
third means for calculating a pressure reduction amount in the reactive gas passage based on a power generation load of the fuel cell stack;
fourth means for calculating a pressure reduction amount in the water passage based on the power generation load of the fuel cell stack;
fifth means for calculating, from the pressure reduction amount in the water passage and the pressure reduction amount in the reactive gas passage, a target pressure of the reactive gas supplied to the reactive gas passage such that a pressure difference between the reactive gas passage and the water passage is within a predetermined range; and
sixth means for controlling the first means based on the target pressure.

28. A control method for a fuel cell system comprising a fuel cell stack effecting power generation upon supply of a reactive gas, the fuel cell stack comprising a reactive gas passage and a water passage substantially parallel to the reactive gas passage, the reactive gas passage and the water passage being separated by a porous member, the reactive gas being humidified by water permeating through the porous member, method comprising:
determining a water pressure in the water passage;
calculating a pressure reduction amount in the reactive gas passage based on a power generation load of the fuel cell stack;
calculating a pressure reduction amount in the water passage based on the power generation load of the fuel cell stack;
calculating, from the pressure reduction amount in the water passage and the pressure reduction amount in the reactive gas passage, a target pressure of the reactive gas supplied to the reactive gas passage such that a pressure difference between the reactive gas passage and the water passage is within a predetermined range; and
controlling the reactive gas pressure supplied to the reactive gas passage based on the target pressure.
